(19) United States
(12) Patent Application Publication
(10) Pub. No.: US 2011/0190025 A1
(43) Pub. Date: Aug. 4, 2011

(54) DEVICE AND METHOD FOR CONTROLLING POWER OF MOBILE COMMUNICATION TERMINAL

(75) Inventors: Chan-Kyu Kim, Seongnam-si (KR); Han-Il Kim, Seoul (KR); Hyung-Kyu Kim, Seoul (KR); Hyoung-Min Nam, Seoul (KR); Yong-Woo Rho, Seoul (KR); Young-Min Oh, Seoul (KR); Hyung-Jin Lim, Seoul (KR); Kyung-Eun Jang, Seoul (KR)

(73) Assignee: PANTECH CO., LTD., Seoul (KR)

(21) Appl. No.: 12/979,832

(22) Filed: Dec. 28, 2010

(30) Foreign Application Priority Data
Jan. 29, 2010 (KR) 10-2010-0008810

(51) Int. Cl. H04B 7/00

(52) U.S. Cl. 455/522

(57) ABSTRACT

A device and method for controlling power for a mobile communication terminal correct a difference between the transmission power of a mobile communication terminal set by a radio frequency (RF) test and the transmission power radiated by the antenna of the mobile communication terminal when communicating with a base station. A device includes a communication path detector to determine whether the mobile communication terminal communicates with RF test equipment or a base station, and a power controller to set a measured power control value for data transmission.

### CROSS REFERENCE TO RELATED APPLICATION

This application claims the priority from and the benefit under 35 U.S.C. §119(a) of Korean Patent Application No. 10-2010-0008810, filed on Jan. 29, 2010, the disclosure of which is incorporated herein by reference for all purposes.

### BACKGROUND OF THE INVENTION

1. Field

The following description relates to a device and method for controlling power of a mobile communication terminal (MCT).

2. Discussion of the Background

In a conventional mobile communication system, multiple MCTs and base is stations (BS) of mobile communication terminals simultaneously use the same frequency band, and as a result, interference occurs between them. Thus, the transmission power of a MCT or BS may need to be controlled to increase the traffic capacity of the BS, extend the battery life of the MCT, and normalize call quality.

Among power control methods, a method for controlling transmission power of a MCT is referred to as reverse power control and a method for controlling the transmission power of a BS is referred to as forward power control.

A MCT undergoes a radio frequency (RF) performance test by RF test equipment before shipment, and the corresponding transmission power of the MCT is set during the test. However, the power set by the RF test equipment may be different from a power actually radiated by the antenna of the MCT, thus resulting in diminished call quality and increased battery consumption. Consequently, such a difference in power may need to be corrected to improve call quality and reduce battery consumption.

### SUMMARY

Exemplary embodiments of the present invention provide a device to control power of a mobile communication terminal to correct a difference between the transmission power of the mobile communication terminal and a transmission power radiated by the antenna of the mobile communication terminal.

Exemplary embodiments of the present invention also provide a method for controlling power of a mobile communication terminal to correct a difference between the transmission power of the mobile communication terminal and a transmission power radiated by the antenna of the mobile communication terminal.

Additional features of the invention will be set forth in the description which follows, and in part will be apparent from the description, or may be learned by practice of the invention.

Exemplary embodiments of the present invention provide a device to control transmission power of a mobile communication terminal. The device includes a communication path detector to determine whether the mobile communication terminal communicates with radio frequency (RF) test equipment or a base station of a mobile communication system, and a power controller to set a first power control value if the communication path detector determines that the mobile communication terminal communicates with the RF test equipment, and to set a second power control value if the communication path detector determines that the mobile communication terminal communicates with the base station.

Exemplary embodiments of the present invention provide a method for controlling transmission power of a mobile communication terminal. The method includes determining whether the mobile communication terminal communicates with radio frequency (RF) test equipment or a base station of a mobile communication system, setting a first power control value if it is determined that the mobile communication terminal communicates with the RF test equipment, and setting a second power control value if it is determined that the mobile communication terminal communicates with the base station.

Exemplary embodiments of the present invention provide a device to control power of a mobile communication terminal. The device includes a communication path detector to determine a communication path of the mobile communication terminal, a power controller to set a power control value according to the determined communication path, and a radio frequency (RF) test switch to set the communication path.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a device for controlling power of a MCT according to an exemplary embodiment.

FIG. 2 is a flowchart illustrating a method for controlling power of a MCT according to an exemplary embodiment.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be is exaggerated for clarity. Like reference numerals in the drawings denote like elements.

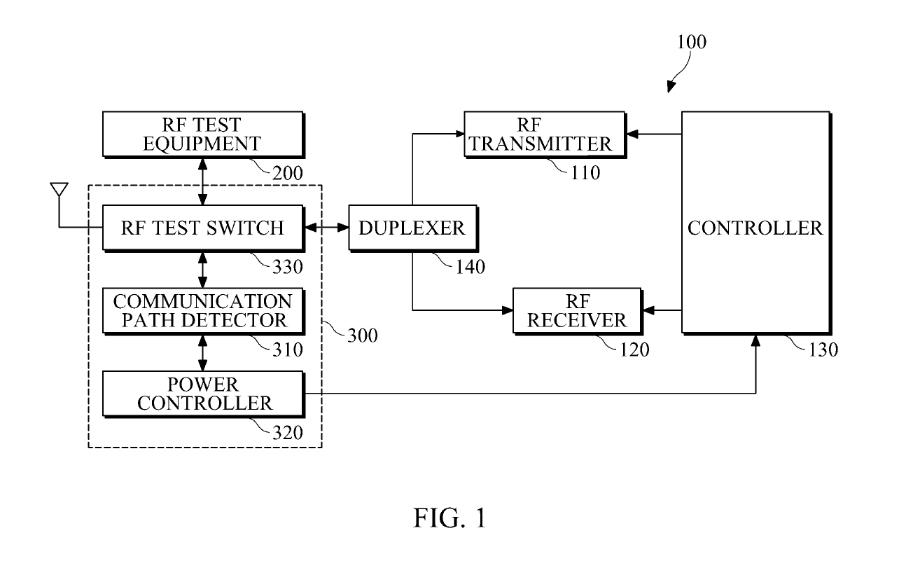

FIG. 1 is a block diagram illustrating a device for controlling power of a MCT according to an exemplary embodiment.

Referring to FIG. 1, a transmission power correcting unit (TPCU) 300 interacts with a MCT 100. As shown in FIG. 1, a MCT 100 may include a radio frequency (RF) transmitter 110 that transmits a wireless frequency signal, a RF receiver 120 that receives a wireless frequency signal, a controller 130 that controls the overall MCT as well as wireless frequency transmission and reception, and a duplexer 140 that separate transmission signals and reception signals.

As shown in FIG. 1, a MCT 100 may undergo an RF performance test by RF test equipment 200 before shipment, and a predetermined transmission power and other attributes of the MCT 100 may be set by the RF test equipment 200 during the test.

Accordingly, the transmission power set by the RF test equipment 200 may be different from the transmission power actually radiated by the antenna of the MCT 100. To improve call quality and reduce battery consumption, such a difference may be corrected by TPCU 300, which controls the power of a MCT 100.

FIG. 1 further illustrates an example of a TPCU 300 for controlling power for a MCT 100. TPCU 300 includes a communication path detector (CPD) 310 and a power controller 320. TCPU 300 may also include an RF test switch 330, which will be described in more detail below.

TPCU 300 may be implemented either as software, hardware, or a combination of software and hardware. TPCU 300 may further be arranged in the MCT 100 or as an element separate from MCT 100.

The CPD 310 may determine whether the MCT 100 communicates with the RF test equipment 200, a BS (not shown), or a different power inducing source.

Accordingly, the CPD 310 may determine whether the MCT 100 communicates with the RF test equipment 200 or the BS based on an applied voltage level. The voltage is applied to the CPD 310 and is measured. The measured voltage level may be determined to be either a “low” level or a “high” level. If the measured applied voltage is determined to be at a “low” level, it may be determined that the MCT 100 communicates with the RF test equipment 200. On the other hand, when the measured applied voltage is at a “high” level, it may be determined that the MCT 100 communicates with the base station of a mobile communication system.

The power controller 320 may perform power control to transmit data using a first power control value (FPCV) when the CPD 310 determines that the MCT 100 communicates with the RF test equipment 200, and may perform power control to transmit data using a second power control value (SPCV) when the CPD 310 determines that the MCT 100 communicates with the BS.

The SPCV may be calculated by adding a correction value to the FPCV. The correction value may be determined according to the design of a RF output system of the MCT 100. Correction value may be determined on the basis of the transmission powers of several MCTs measured in an anechoic chamber.

The FPCV may be determined according to the receive signal strength indicator (RSSI) or signal-to-noise ratio (SNR) of a signal received from the RF test equipment 200.

Accordingly, the power controller 320 may measure the RSSI of a signal received from the RF test equipment 200 and then compare the measured RSSI with a set value. If the is measured RSSI is less than the set value, then FPCV may be increased. If the measured RSSI is greater than the set value then FPCV may be decreased.

Likewise, the power controller 320 may measure the SNR of a signal received from the RF test equipment 200 and then compare the measured SNR with a set value. If the measured SNR is less than the set value, then FPCV may be increased. If the measured SNR is greater than the set value then FPCV may be decreased.

As mentioned above, SPCV may be calculated by adding a correction value to the FPCV. The TPCU 300 may determine the FPCV on the basis of the transmission power of the RF test equipment 200 and determine a correction value. By summing up the FPCV and the correction value obtained, a corresponding SPCV may be calculated. Then SPCV may be transmitted in appropriate situations to aid in more accurate control of power transmission.

Accordingly, since a difference between the transmission power of a MCT set by performing a RF test and a transmission power radiated by the antenna of the MCT during an actual communication with a BS may be corrected, it may be possible to improve the call quality of the MCT and reduce battery consumption. Also, a specific absorption rate (SAR) may be improved by power control.

The TPCU 300 may further include an RF test switch 330. The RF test switch 330 switches between the first path that connects the MCT 100 with the RF test equipment 200 and the second path that connects the MCT 100 with a BS (not shown).

The RF test switch 330 may be used for determining whether the MCT 100 communicates with the RF test equipment 200 or a BS. The RF test switch 330 switches between the first path and the second path to determine a communication path.

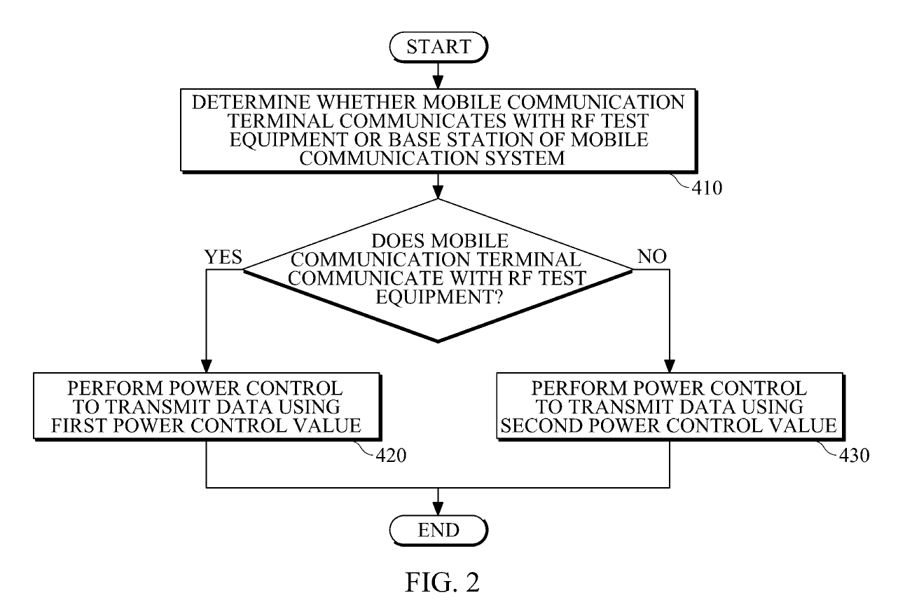

A power control operation for controlling power of a MCT will be described is below in reference to FIG. 2. FIG. 2 is a flow chart illustrating a method for controlling power of a MCT according to an exemplary embodiment.

As shown in FIG. 2, in operation 410, it is determined whether the MCT communicates with RF test equipment or a BS. If it is determined in operation 410 that the MCT communicates with RF test equipment, then power control is performed in operation 420 so that the MCT transmits data using a FPCV. If it is determined in operation 410 that the MCT communicates with a BS, power control is performed in operation 430 so that the MCT transmits data using a SPCV.

The FPCV may be determined according to the RSSI or SNR of a signal received from the RF test equipment.

Accordingly, in operation 420, a MCT may measure the RSSI of a signal received from the RF test equipment and then compare the measured RSSI with a set value. If the measured RSSI of the received signal is less than the set value, then the FPCV is increased. If the measured RSSI of the received signal is greater than the set value, then the FPCV is reduced.

Likewise, in operation 420, a MCT may measure the SNR of a signal received from the RF test equipment and then compare the measured SNR with a set value. If the measured SNR is less than the set value, then the FPCV is increased. If the measured SNR is greater than the set value, then the FPCV is reduced.

The SPCV is a value calculated by adding a correction value to the FPCV. The correction value may be determined according to the design of a RF output system of the MCT. Correction value may be obtained on the basis of the transmission powers of several MCTs measured in an anechoic chamber.

The disclosed method determines the FPCV on the basis of the transmission is power of RF test equipment. By summing up the FPCV and the obtained correction value, the corresponding SPCV may be calculated. Then SPCV will be transmitted in appropriate situation aiding in more accurate control of power transmission.

Accordingly, since a difference between the transmission power of a MCT set by performing a RF test and a transmission power radiated by the antenna of the MCT during an actual communication with a BS can be corrected, it is possible to improve the call quality of the MCT and reduce battery consumption. Also, a SAR may be improved by power control.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A device to control transmission power of a mobile communication terminal, comprising:
a communication path detector to determine whether the mobile communication terminal communicates with radio frequency (RF) test equipment or a base station of a mobile communication system; and
a power controller to set a first power control value if the communication path detector determines that the mobile communication terminal communicates with the RF test equipment, and to set a second power control value if the communication path detector determines that the mobile communication terminal communicates with the base station.

2. The device of claim 1, wherein the first power control value is determined according to a receive signal strength indicator (RSSI) of a signal received from the RF test equipment.

3. The device of claim 2, wherein if the RSSI is less than a set value, the first power control value is increased.

4. The device of claim 2, wherein if the RSSI is greater than a set value, the first power control value is decreased.

5. The device of claim 1, wherein the first power control value is determined according to a signal-to-noise ratio (SNR) of a signal received from the RF test equipment.

6. The device of claim 1, wherein the second power control value is calculated by adding a correction value to the first power control value.

7. The device of claim 6, wherein the correction value is determined according to a design of an RF output system of the mobile communication terminal.

8. The device of claim 6, wherein the correction value is determined on the basis of transmission powers of a plurality of mobile communication terminals measured in an anechoic chamber.

9. The device of claim 1, further comprising an RF test switch to switch between a first path to connect the mobile communication terminal with the RF test equipment and a second path to connect the mobile communication terminal with the base station.

10. The device of claim 1, wherein the communication path detector determines whether the mobile communication terminal communicates with the RF test equipment or the base station according to an applied voltage level.

11. A method for controlling transmission power of a mobile communication terminal, comprising:
determining whether the mobile communication terminal communicates with radio frequency (RF) test equipment or a base station of a mobile communication system;
setting a first power control value if it is determined that the mobile communication terminal communicates with the RF test equipment; and
setting a second power control value if it is determined that the mobile communication terminal communicates with the base station.

12. The method of claim 11, further comprising determining the first power control value according to a receive signal strength indicator (RSSI) of a signal received from the RF test equipment.

13. The method of claim 12, wherein determining the first power control value further comprises increasing the first power control value if the RS SI is less than a set value, and decreasing the first power control value if the RSSI is greater than the set value.

14. The method of claim 11, further comprising determining the first power control value according to a signal-to-noise ratio (SNR) of a signal received from the RF test equipment.

15. The method of claim 11, further comprising determining the second power control value by adding a correction value to the first power control value.

16. The method of claim 15, further comprising determining the correction value according to a design of an RF output system of the mobile communication terminal.

17. The method of claim 15, further comprising determining the correction value on the basis of transmission powers of a plurality of mobile communication terminals measured in an anechoic chamber.

18. A device to control power of a mobile communication terminal, comprising:
a communication path detector to determine a communication path of the mobile communication terminal;
a power controller to set a power control value according to the determined communication path; and
a radio frequency (RF) test switch to set the communication path.

19. The device of claim 18, wherein the RF test switch sets a first communication path to connect the mobile communication terminal with RF test equipment or a second path to connect the mobile communication terminal with a base station of a mobile communication system.

20. The device of claim 18, wherein the communication path detector determines the communication path according to an applied voltage level.
